(19) United States
(12) Patent Application Publication
(10) Pub. No.: US 2025/0044123 A1
(43) Pub. Date: Feb. 6, 2025

(54) SYSTEM AND METHOD FOR REDUCING ERROR CAUSED BY ROTATIONAL MOVEMENT DURING POSITION SENSING

(71) Applicant: Altronic, LLC., Girard, OH (US)

(72) Inventors: Matthew Traina, JR., Ravenna, OH (US); Joseph Martin Lepley, Ashtabula, OH (US); Frank Andrew Krempasky, Youngstown, OH (US); Jacob Allen Jones, Warren, OH (US)

(73) Assignee: Altronic, LLC., Girard, OH (US)

(21) Appl. No.: 18/229,425

(22) Filed: Aug. 2, 2023

(51) Int. Cl. G01D 5/14; G01D 5/16

(52) U.S. Cl. CPC G01D 5/145; G01D 5/16

(57) ABSTRACT

A method of reducing error caused by rotational movement during position sensing in a system comprising a magnetic rod attached to a movable object, two or more linear position sensors positioned substantially equidistant to each other on a radius around the magnetic rod attached to the movable object, and electronics is disclosed. The method includes measuring magnetized lines of flux being radiated from the magnetic rod attached to the movable object, the linear position sensors translating respective sensed lines of flux into corresponding voltage and using the electronics to sum the corresponding signals i.e., voltages, and determine the average of the corresponding signals, i.e., voltages.

### BACKGROUND

The present exemplary embodiment relates to systems and methods for sensing the position of a linearly moving object. It finds a particular application in conjunction with fuel regulating valves and will be described with a particular reference thereto. However, it is to be appreciated that the present exemplary embodiment is also amenable to other like applications.

It is known to use a magnetic rod to sense the position of a moving object in a linear motion of a fuel regulating valve. As to not affect the forces acting on the object, contactless measurement is generally used. Additionally, any contact to the magnetic rod for placement must be minimized for wear and to reduce the effect of forces on the object. A magnetic field is used in conjunction with the magnetic rod to create lines of flux that a contactless sensor can use to infer the position. Due to the way the magnetic lines of flux are created, if rotated, the lines of flux can change in intensity, thus causing changes in the inferred object position. Although the object position has not actually moved in any linear direction, a problem arises when the object changes its angular position (i.e., rotates). In a system where knowing the exact position of an object is critical, having a change in reported position without there actually being a change in physical position is detrimental.

Thus, there is a need for a solution to the above-noted problem that would greatly reduce the amount of falsely reported movement in position due to angular movement of the object. In this approach, mechanical anti rotation is not needed, and the magnetic rod can spin freely.

### BRIEF DESCRIPTION

Various details of the present disclosure are hereinafter summarized to provide a basic understanding. This summary is not an extensive overview of the disclosure and is intended neither to identify certain elements of the disclosure, nor to delineate the scope thereof. Rather, the primary purpose of the summary is to present certain concepts of the disclosure in a simplified form prior to the more detailed description that is presented hereinafter.

The attachment of a magnetic rod to the movable object in a fuel regulating valve allows lines of flux to radiate from the magnetic rod. Contactless sensors, e.g., Hall effect sensors, are then positioned substantially equidistant to each other on a radius around the magnetic rod attached to the movable object. Each contactless sensor will then translate its sensed lines of flux into a corresponding signal, i.e., a voltage. Electronic circuitry is then used to sum and average each sensor's corresponding signal. As the magnetic rod, and consequently lines of flux rotate, each contactless sensor will reduce or increase its output signal based on the lines of magnetic flux that it senses. With a plurality of contactless sensors, the output changes from the electronic circuit are reduced in error percentage closer to zero. An increase in the number of sensors will lead to a decrease in observed position error. If the error is averaged out and kept constant, it is much easier to determine the location of the object. In this approach, mechanical anti-rotation is not needed, and the magnetic rod can spin freely with no added frictional loss.

In one embodiment, a system for reducing the error caused by rotational movement during position sensing is provided. The system includes a magnetic rod attached to a movable object, wherein the magnetic rod is configured to create lines of flux, two or more linear position sensors configured to translate respective sensed lines of flux into corresponding signals, i.e., voltages, wherein the two or more linear position sensors are positioned substantially equidistant to each other on a radius around the magnetic rod attached to the movable object, and electronics configured to sum the corresponding signals, i.e., voltages, and determine the average of the corresponding signals, i.e., voltages.

In another embodiment, a method of reducing error caused by rotational movement during position sensing in a system comprising of a magnetic rod attached to a movable object, two or more linear position sensors positioned substantially equidistant to each other on a radius around the magnetic rod attached to the movable object, and electronics is provided. The method includes measuring magnetized lines of flux being radiated from the magnetic rod attached to the movable object, the linear position sensors translating respective sensed lines of flux into corresponding signal, i.e., voltages, and using the electronics to sum the corresponding signals, i.e., voltages, and determine the average of the corresponding signals, i.e., voltages.

Optionally, and in accordance with any of the above aspects of the exemplary embodiment, each linear position sensor reduces or increases its output signal based on the lines of magnetic flux that it senses.

Optionally, and in accordance with any of the above aspects of the exemplary embodiment, a circular permanent magnet is attached to the magnetic rod to create lines of flux.

Optionally, and in accordance with any of the above aspects of the exemplary embodiment, the corresponding signals comprise voltages.

Optionally, and in accordance with any of the above aspects of the exemplary embodiment, the linear position sensors comprise contactless sensors. The contactless sensors may comprise Hall effect sensors and/or magneto restrictive or magneto resistive sensors. Optionally, the contactless sensors are substantially equidistant from the centerline of the magnetic rod.

Further scope of the applicability of the exemplary embodiment will become apparent from the detailed description provided below. It should be understood, however, that the detailed description and specific examples, while indicating preferred embodiments, are given by way of illustration only, since various changes and modifications within the spirit and scope of the exemplary embodiment will become apparent to those skilled in the art.

### BRIEF DESCRIPTION OF THE DRAWINGS

The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Other objects, advantages and novel features of the disclosure will be set forth in the following detailed description of the disclosure when considered in conjunction with the drawings, in which:

FIG. 1 is top view of a position sensing system with only a single sensor;

FIG. 2 is a profile view of the magnetic rod shown in FIG. 1 and showing the lines of flux;

FIG. 3 is a graph that shows the full stroke versus the error that can result from rotating the magnetic rod;

FIG. 4 is a block diagram of an exemplary position sensing system showing the general setup of a plurality of sensors relative to a magnet in accordance with aspects of the exemplary embodiment;

FIG. 5 is a top view of the exemplary position sensing system with a plurality of sensors in accordance with other aspects of the exemplary embodiment;

FIG. 6 is a schematic circuit diagram of a summing and averaging circuit in accordance with aspects of the exemplary embodiment; and

FIG. 7 is flow chart of a method of sensing the position of a linearly moving object in a fuel regulating valve in accordance with aspects of the exemplary embodiment.

### DETAILED DESCRIPTION

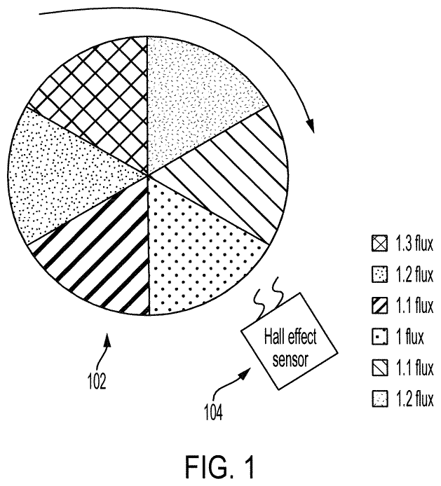

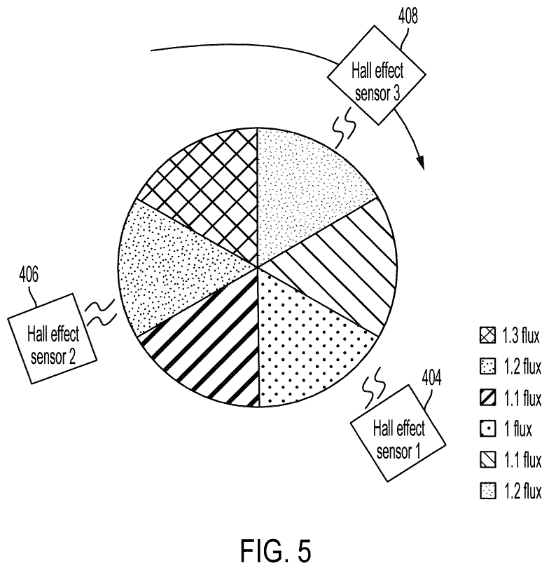

Referring now to the drawings wherein the showings are for purposes of illustrating the exemplary embodiments only and not for purposes of limiting the claimed subject matter, FIG. 1 is a top view block diagram of a system for position sensing of a movable object in a device such as a fuel regulating valve. In the system, magnetized lines of flux are radiated from a magnetic rod 102 attached to the movable object in the fuel regulating valve. Placed next to the magnetic rod 102 is a linear position sensor 104. Due to the sensing characteristics needed, a contactless sensor, such as a Hall effect sensor, is generally used in the system. The sensor 104 may be used to translate sensed lines of flux into corresponding signals, i.e., voltages. It is noted that the lines of flux depicted in FIG. 1 (and in FIG. 5) are shown as a pie. This is only a representation and for demonstration purposes, as lines of are generally linear in nature. The position sensing design is meant for the shaft (i.e., the movable object) to move up and down, not in rotation.

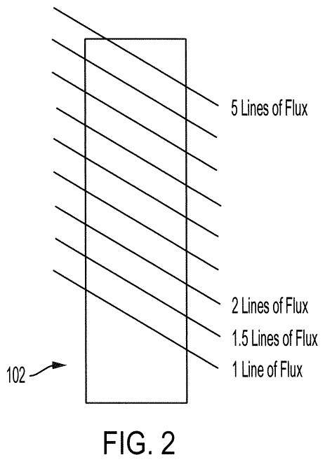

FIG. 2 is a profile view of the magnetic rod 102, indicating the lines of flux not perpendicular to the magnetic rod 102. Because lines of flux are not perfectly perpendicular, they add an offset as described in the top-down view of FIG. 1.

In this example, only one contactless sensor, such as the contactless sensor 104, is placed in a location relative to the magnetic rod 102. Thus, error is introduced when only the single sensor is used. Different lines of flux radiate from the magnetic rod 102, and each has its own associated flux value, because the lines of flux are not completely perpendicular to the center of the radiating rod. This then causes an undesirable error.

With respect to the example shown in FIG. 2, there is a relationship between normalized lines of flux and the corresponding voltage. For example, if 1X lines of flux=1V, then 1.1X lines of flux=1.1V, 1.2X lines of flux=1.2V, 1.3X lines of flux=1.3V, and so on.

Further, if for the entire available stroke 1 line of flux=0% and 5X lines of flux=100%, then, given the math, 0.040V=1% of entire available stroke. Thus, as the shaft 102 rotates it causes an error in the reported position represented by the following formula:

$$( Lines of flux - 1 ) / \text{.040} = error \%$$

For example:

$$( 1.1 - 1 ) = 0.1$$

$$0.1 / \text{.040} = 2.5 \% error$$

In this example with one sensor the error can be as great as:

$$( 1.3 - 1.1 ) / \text{.040} = 7.5 \% error$$

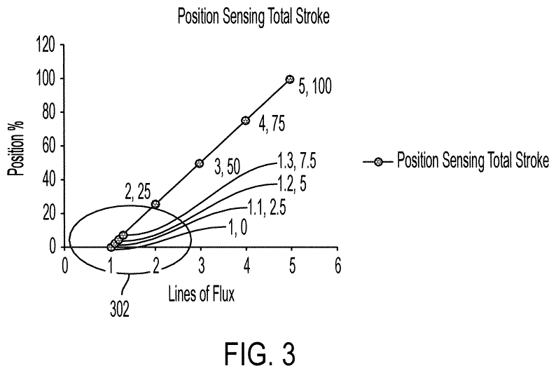

FIG. 3 is a graph that shows the demonstration of full stroke versus the error that can result from rotating the magnetic rod. The circled area 302 represents error from the rotation of the magnetic rod 102 in the case with only one sensing element.

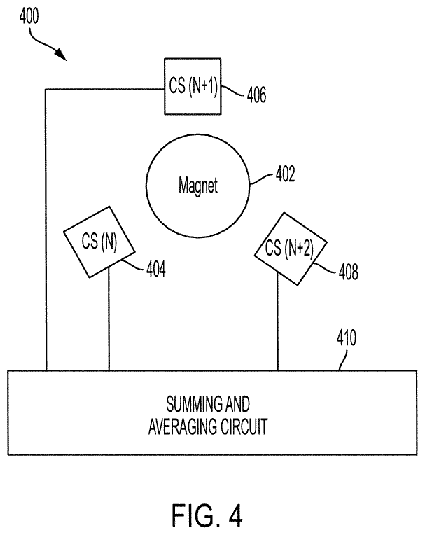

FIG. 4 is a top view block diagram of an exemplary system 400 for reducing error caused by rotational movement during position sensing of a movable object in a fuel regulating valve. In the system 400, magnetized lines of flux are radiated from a magnetic rod (or shaft) 402 attached to the movable object in the fuel regulating valve. Although the exemplary system 400 shown in FIG. 4 uses a circular permanent magnet attached to the magnetic rod 402 to create lines of flux, it is to be understood that other means of creating lines of flux may be utilized in the system 400, such as different shapes of magnets, rods, or technology relating to magnetism, such as electromagnets.

Placed around the magnetic rod 402 are multiple linear position sensors 404, 406, and 408. Due to the sensing characteristics needed, contactless sensors, such as Hall effect sensors, are generally used in the system 400. It is to be understood, however, that other types of contactless sensors may be used, such as magneto restrictive or magneto resistive sensors. The contactless sensors 404, 406, and 408 are positioned substantially equidistant from each other on a radius around the magnetic rod 402, which is attached to the movable object. In particular, the contactless sensors 404, 406, and 408 are substantially equidistant from the centerline of the magnetic rod 402. In this example there are three contactless sensors (i.e., 404, 406, and 408) shown. However, it is to be appreciated that any number of contactless sensors may be used, so long as there is more than one sensor in the system 400. The sensors 404, 406, and 408 are used to translate sensed lines of flux into corresponding signals, i.e., voltages. The corresponding signals, i.e., voltages, are then summed and averaged to counteract any rotational movement of the magnetic rod 402 using a summing and averaging circuit 410, thus reducing the need for mechanical anti-rotation. It is noted that the position sensing design is meant for the shaft (i.e., the movable object) to move up and down, not in rotation.

FIG. 5 is a block diagram showing an example of how error is reduced using the exemplary position sensing system 400. In this example and as described above, the multiple contactless sensors 404, 406, and 408 are placed in a location relative to the magnetic rod 402. Different lines of flux radiate from the magnetic rod 402. Each line of flux has its own associated flux value (i.e., 1 line of flux, 1.1 lines of flux, 1.2 lines of flux, 1.3 lines of flux, and so on), because the lines of flux are not completely perpendicular to the center of the radiating magnetic rod 402. This feature then causes an undesirable error. The use of multiple sensors in this novel approach allows the error reported by the angular movement of the magnetic rod 402 to approach zero. In this embodiment, three contactless sensors 404, 406, and 408 are placed substantially equidistant from the centerline of the magnet. These sensors then will translate their sensed lines of flux into a corresponding signal, i.e., a voltage.

With respect to the example shown in FIG. 5, there is a relationship between normalized lines of flux and the corresponding voltage. For example, if 1X lines of flux=1V, then 1.1X lines of flux=1.1V, 1.2X lines of flux=1.2V, 1.3X lines of flux=1.3V, and so on.

Further, if for the entire available stroke 1 line of flux=0% and 5X lines of flux=100%, then, given the math, 0.040V=1% of entire available stroke. Thus, as the shaft 402 rotates it causes an error in the reported position, because the lines of flux are not perpendicular to the center of the radiating rod 402. In this example with three averaged sensors the 0% calibration is now shifted to the average of 1.14V.

Electronics 410 are then used to sum and average each sensor's corresponding voltage. This means that as the magnetic rod 402 and consequently the lines of flux rotate, each of the contactless sensors 404, 406, and 408 will then reduce or increase its output voltage due to the changing lines of flux, because the lines of flux are not perpendicular to the center of the radiating rod. These values will then be averaged to reduce any observed error in the position of the object. Thus, an aspect of the exemplary embodiment is adding sensors to sense more points and average out the error. This then keeps it a substantially constant error. Additionally, the more sensors the device has the closer to zero the substantially constant error can become.

The formula thus becomes:

$$( ( Lines of flux 1 - 1.14 ) + ( Lines of flux 2 - 1.14 ) + ( Lines of flux 3 - 1.14 ) ) / \text{.040} = error \%$$

By way of example:

$$( ( 1 - 1.14 ) + ( 1.2 - 1.14 ) + ( 1.2 - 1.14 ) ) / 0.4 = 1 \% error$$

The result is that no matter how the shaft rotates the result is an error of roughly 1% in this example, versus a single sensor that can demonstrate an error of up to 15%. Thus, a valuable aspect of the exemplary system is that it takes any three (or more) physically possible values of the offsets, and they will aways average to approximately the same value.

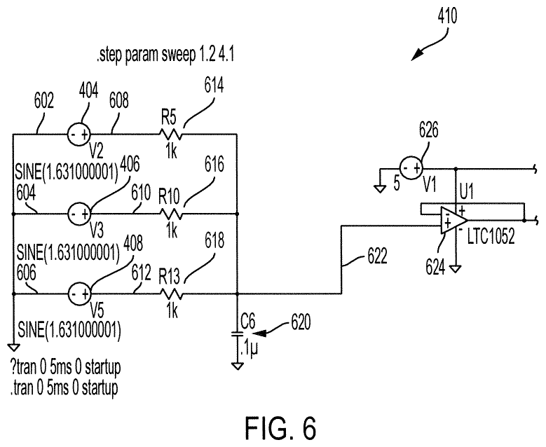

FIG. 6 is a schematic diagram of the summing and averaging circuit 410 that processes the data received from the contactless sensors (i.e., 404, 406, and 408). In the summing and averaging circuit 410, the contactless sensors 404, 406, and 408 receive as inputs (602, 604, and 606) the lines of flux, respectively, and convert these values to corresponding output voltages 608, 610, and 612. Each corresponding output voltage value 608, 610, and 612 is then passed through one of the corresponding resistors 614, 616, and 618, respectively, and a capacitor 620. This approach allows the summing and averaging circuit 410 to filter out the unwanted high frequency signals. The resulting value 622 is then used as the input of a negative feedback operational amplifier 624 to stabilize the output of the summing and averaging circuit 410. The summing and averaging circuit 410 also includes a power supply 626.

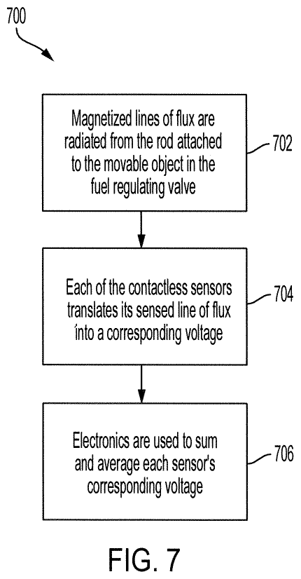

FIG. 7 shows an exemplary method 700 of reducing error caused by rotational movement during position sensing of a linearly moving object in a fuel regulating valve. As discussed earlier and with continued reference to FIGS. 4-6, a plurality of contactless sensors (i.e., 404, 406, and 408) are positioned substantially equidistant to each other on a radius around a magnetic rod 402 attached to the movable object in the fuel regulating valve. The contactless sensors 404, 406, and 408 are substantially equidistant from the centerline of the magnetic rod 402.

Magnetized lines of flux are radiated from the magnetic rod 402 attached to the movable object in the fuel regulating valve and sensed by the contactless sensors (i.e., 404, 406, and 408) (702). Each of the contactless sensors 404, 406, and 408 translates its sensed line of flux into a corresponding voltage (704). Electronics 410 are used to sum and average the corresponding voltage from each of the sensors 404, 406, and 408 (706).

As the magnetic rod 402, and consequently lines of flux, rotates, each of the contactless sensors 404, 406, and 408 may reduce or increase its output voltage based on the lines of magnetic flux sensed by the respective sensor. With a plurality of contactless sensors 404, 406, and 408 the output change from the electronic circuit 410 is reduced in error percentage closer to zero error. Adding more sensors to the system 400 will generally reduce any observed error closer to zero. It is further noted that the voltages could be processed by a micro controller.

The above description merely provides a disclosure of particular embodiments and is not intended for the purposes of limiting the same thereto. As such, the exemplary embodiment is not limited to only the above-described embodiments. Rather, it is recognized that one skilled in the art could conceive alternative embodiments that fall within the scope of the exemplary embodiment.

1. A system for reducing error caused by rotational movement during position sensing, the system comprising:
a magnetic rod attached to a movable object, wherein the magnetic rod is configured to create lines of magnetic flux;
two or more linear position sensors configured to translate respective sensed lines of magnetic flux into corresponding output signals, wherein the two or more linear position sensors are positioned substantially equidistant to each other on a radius around the magnetic rod attached to the movable object; and
electronics configured to sum the corresponding signals and determine the average of the corresponding signals.

2. The system of claim 1, wherein each linear position sensor reduces or increases its output signal based on the lines of magnetic flux that it senses.

3. The system of claim 1, wherein a circular permanent magnet is attached to the magnetic rod to create lines of flux.

4. The system of claim 1, wherein the corresponding signals comprise voltages.

5. The system of claim 1, wherein the linear position sensors comprise contactless sensors.

6. The system of claim 5, wherein the contactless sensors comprise Hall effect sensors.

7. The system of claim 5, wherein the contactless sensors comprise magneto restrictive or magneto resistive sensors.

8. The system of claim 5, wherein the contactless sensors are substantially equidistant from the centerline of the magnetic rod.

9. A method of reducing error caused by rotational movement during position sensing in a system comprising a magnetic rod attached to a movable object, two or more linear position sensors positioned substantially equidistant to each other on a radius around the magnetic rod attached to the movable object, and electronics, the method comprising:
measuring magnetized lines of flux being radiated from the magnetic rod attached to the movable object;
the linear position sensors translating respective sensed lines of flux into corresponding signals; and
using the electronics to sum the corresponding signals and determine the average of the corresponding signals.

10. The method of claim 9, wherein each linear position sensor reduces or increases its output signal based on the lines of magnetic flux that it senses.

11. The method of claim 9, wherein a circular permanent magnet is attached to the magnetic rod to create lines of flux.

12. The method of claim 9, wherein the corresponding signals comprise voltages.

13. The method of claim 9, wherein the linear position sensors comprise contactless sensors.

14. The method of claim 13, wherein the contactless sensors comprise Hall effect sensors.

15. The method of claim 13, wherein the contactless sensors comprise magneto restrictive or magneto resistive sensors.

16. The method of claim 13, wherein the contactless sensors are substantially equidistant from the centerline of the magnetic rod.
